(19) United States
(12) Patent Application Publication
(10) Pub. No.: US 2012/0139191 A1
(43) Pub. Date: Jun. 7, 2012

(54) Polyvinyl Chloride Foam Gasket

(75) Inventors: Sangmin Park, Seoul (KR); Sungho Bae, Seoul (KR); Kyungho Lee, Incheon (KR)

(73) Assignee: SAINT-GOBAIN PERFORMANCE PLASTICS CORPORATION, Aurora, OH (US)

(21) Appl. No.: 13/310,634

(22) Filed: Dec. 2, 2011

Related U.S. Application Data
(60) Provisional application No. 61/419,090, filed on Dec. 2, 2010.

(30) Foreign Application Priority Data
Jan. 19, 2011 (KR) 20-2011-0000538

(51) Int. Cl. F16J 15/02; B29C 53/36

(52) U.S. Cl. 277/641; 156/217

(57) ABSTRACT

A sealing assembly includes a component, a polyvinyl chloride foam gasket, a double sided acrylic tape, and a butyl tape. The component has a wall, an interior space defined by the wall, and an opening extending through the wall into the interior space. The wall has a rib extending therefrom and surrounding the opening. The gasket has a base, two sides, first and second ends, a length, and a groove formed therein and defined by the two sides and the base of the gasket. The groove extends along the length of the gasket. The gasket is positioned along the rib such that the rib extends into the groove, the gasket extends around the opening and the first and second ends of the gasket abut.

Accordingly, upon entry of the amendment to the abstract, the new abstract reads:

A sealing assembly includes a component, a polyvinyl chloride foam gasket, a double sided acrylic tape, and a butyl tape. The component has a wall, an interior space defined by the wall, and an opening extending through the wall into the interior space. The wall has a rib extending therefrom and surrounding the opening. The gasket has a base, two sides, first and second ends, a length, and a groove formed therein and defined by the two sides and the base of the gasket. The groove extends along the length of the gasket. The gasket is positioned along the rib such that the rib extends into the groove, the gasket extends around the opening and the first and second ends of the gasket abut.

### CROSS-REFERENCE TO RELATED APPLICATION(S)

The following disclosure is a non-provisional application which claims priority to U.S. Provisional Application No. 61/419,090 filed Dec. 2, 2010, entitled “Polyvinyl Chloride Foam Gasket” and having named inventors Sangmin Park, Sugho Bae and Kyungho Lee, and further claims priority to Korean Application No. 20-2011-0000538 filed Jan. 19, 2011, entitled “Polyvinyl Chloride Foam Gasket” and having named inventors Sangmin Park, Sugho Bae and Kyungho Lee, the applications of which are incorporated by reference herein in their entirety.

### FIELD OF THE DISCLOSURE

The present disclosure generally relates to polyvinyl chloride foam gaskets.

### BACKGROUND

Gaskets that are placed between two components to provide a seal are generally known. For example, gaskets can be used to fill a gap between the two components to prevent dirt, water, or other materials from infiltrating the interior space. In automotive applications, the gasket may be used between a lamp housing and the car body to prevent water from infiltrating the lamp housing and corroding or shorting the lamp electrical system. In particular applications, the gasket can be reusable to enable replacement of components, such as light bulbs, that are housed within the interior space. There is an ongoing need for improved gaskets that offer increased performance.

### SUMMARY

In a first aspect, a sealing assembly can include a component, a polyvinyl chloride foam gasket, a double sided acrylic tape, and a butyl tape. The component can have a wall, an interior space defined by the wall, and an opening extending through the wall into the interior space. The wall can have a rib extending therefrom and surrounding the opening. The gasket can have first and second ends, a length, and a groove formed therein and defined by a base and two side of the gasket. The groove extending along the length of the gasket. The gasket can be positioned along the rib such that the rib extends into the groove and the gasket extends around the opening, and the first and second ends abut. The double sided acrylic tape can be positioned between the rib and the groove to adhere the gasket to the rib and to pull the sides of the gasket towards the rib when the rib is inserted into the groove. The butyl tape can be positioned at the abutting first and second ends of the gasket. In an embodiment, the component can be an automotive component, such as a lamp assembly. In another embodiment, the gasket can include an extruded polyvinyl chloride foam.

In a second aspect, a vehicle assembly can include a vehicle body; a lamp assembly joined to the vehicle body, and a peripheral seal between the lamp assembly and the vehicle body. The lamp assembly can include a housing can have a wall, an interior space defined by the wall, and an opening extending through the wall into the interior space. Additionally, the lamp assembly can include a lamp within the interior space of the lamp assembly. The peripheral seal can be in a closed loop around the opening in the housing and can form a water-tight seal to substantially prevent weather elements from infiltrating the interior space.

The peripheral seal can include a polyvinyl chloride foam and a double sided acrylic tape. The polyvinyl chloride foam can have first and second ends, a length, and a groove formed therein and defined by two sides and a base of the gasket. The groove can extend along the length of the gasket. The polyvinyl chloride foam can extend around the opening, and the first and second ends can abut. The double sided tape can be positioned between the lamp assembly and the polyvinyl chloride foam to adhere the gasket to the rib and can pull the sides of the gasket towards the rib when the when the rib is inserted into the groove.

In a third embodiment, a lens fixture for attachment to a structure can include a housing, a closure, and a peripheral seal. The housing can have a wall, an interior space defined by the wall and an opening extending through the wall into the interior space. The wall can have a rib extending therefrom and surrounding the opening. A portion of the wall can be transparent or translucent to a portion of the electromagnetic spectrum. The portion of the electromagnetic spectrum can be selected from the group consisting of near infrared, visible light, near ultraviolet, and any combination thereof. The interior space can be configured to receive an active element active in the portion of the electromagnetic spectrum. The closure can be attached to the housing and can cover the opening. The peripheral seal can be positioned between the lamp assembly and the vehicle body. The peripheral seal can be arranged in a closed loop around the opening in the housing and forming a water-tight seal to substantially prevent weather elements from infiltrating the interior space.

The peripheral seal can include a polyvinyl chloride foam gasket and a double sided acrylic tape. The gasket can have first and second ends, a length, and a groove formed therein and defined by two sides and a base of the gasket. The groove can extend along the length of the gasket. The gasket can be positioned along the rib such that the rib extends into the groove, the gasket extends around the opening, and the first and second ends abut. The double sided acrylic tape can be positioned between the housing and the gasket to adhere the gasket to the rib and to pull the sides of the gasket towards the rib when the when the rib is inserted into the groove.

In an embodiment of the first, second, or third aspects, the assembly can have a pressurized water rating of at least 0.13 kg/cm². The gasket can have a density in a range of about 90 kg/m³ and about 235 kg/m³, such as in a range of about 100 kg/m³ and about 230 kg/m³, even in a range of about 110 kg/m³ and about 225 kg/m³. Additionally, the gasket can have a force to achieve 30% compression in a range of about 17 kPa and about 180 kPa, such as in a range of about 18.5 kPa and about 100 kPa.

In a forth aspect, a method of sealing a component can include providing the component having a wall, an interior space defined by the wall, and an opening extending through the wall. The wall can have a rib extending therefrom and surrounding the opening. The method can further include applying a gasket to the rib. The gasket can include a polyvinyl chloride foam and can having first and second ends, a substantially rectangular cross section, and a groove formed therein. The gasket can be positioned so that the rib extends into the groove and the first and second ends of the gasket are abutting. Additionally, the rib can be bonded to the polyvinyl chloride foam with a double sided acrylic tape. The method can further include applying a butyl tape to join the first and second ends of the gasket.

In an embodiment of the forth aspect, the method can further include positioning the acrylic tape within the groove prior to applying the gasket to the rib. Additionally, the method can include inserting the component into a body to form a water tight seal. In an embodiment, the water tight seal can have a pressurized water rating of at least 0.13 kg/cm².

In a fifth aspect, a gasket can include a strip of material having a length and a groove formed therein and extending along the length. The material can have a cross-section perpendicular to the length. The groove can include a guide channel for aligning a double sided acrylic tape and a receiving channel for receiving a rib of a component. The receiving channel can be substantially centered within the guide channel.

In an embodiment of the fifth aspect, the material can include a foam, such as an extruded foam. The material can be a polyvinyl chloride foam. The material can have a density in a range of about 90 kg/m³ and about 235 kg/m³, and can have a force to achieve 30% compression in a range of about 17 kPa and about 180 kPa.

In another embodiment of the fifth aspect, the material can have a height in a range of about 5 mm to about 20 mm, such as in a range of about 7 mm to about 15 mm. Additionally, the material can have a width in a range of about 5 mm to about 20 mm, such as in a range of about 7 mm to about 15 mm. The groove can have a receiving channel depth in a range of about 2 mm to about 10 mm, such as in a range of about 3 mm to about 7 mm, and a receiving channel width in a range of about 1 mm to about 4 mm. The ratio of the receiving channel depth to the receiving channel width can be at least about 2:1.

In another embodiment of the fifth aspect, the gasket can further include a double sided tape, such as an acrylic tape. The double sided tape can be positioned within the guide channel and can span the receiving channel. The material can include first and second ends joined together with a sealant, such as a butyl tape

In a sixth aspect, a sealing kit can include a polyvinyl chloride foam gasket, a double sided acrylic tape, and a butyl tape. The gasket can have a base, two sides, a length, and a groove formed therein defined by the base and the two sides. The groove can extend along the length of the gasket. The gasket can have a compressible portion extending from a base of the groove to a base of the gasket. The compressible portion can have a height in a range of 2.5 mm to 10 mm, and the groove can have a depth of 2.5 mm to 10 mm. The double sided acrylic tape can have a length substantially similar to the length of the gasket.

### BRIEF DESCRIPTION OF THE DRAWINGS

The present disclosure may be better understood, and its numerous features and advantages made apparent to those skilled in the art by referencing the accompanying drawings.

FIG. 1 illustrates a component according to an aspect of the present disclosure.

FIG. 2 illustrates a component mounted on a housing with a gasket therebetween to provide a weatherproof seal according to an aspect of the present disclosure.

FIGS. 3 and 4 show cross sections of an exemplary gasket illustrating a method of applying the gasket to a rib according to aspects of the present disclosure.

FIG. 5 shows a cross section of an exemplary gasket illustrating a method of sealing the ends of the gasket.

FIG. 6 shows a side view of an exemplary gasket illustrating another method of sealing the ends of the gasket.

FIGS. 7 and 8 show cross sections of another exemplary gaskets according to aspects of the present disclosure.

FIGS. 9 and 10 show cross sections of another exemplary gasket illustrating a method of applying the gasket to a rib according to aspects of the present disclosure.

The use of the same reference symbols in different drawings indicates similar or identical items.

### DETAILED DESCRIPTION

In an embodiment, a gasket can be applied to a component, such as a lamp housing, to provide a weatherproof seal. The gasket can have a length and a groove extending along the length. The component can have a rib encircling an opening, and the gasket can be positioned around the opening with the rib extending into the groove. The gasket can be a foam, such as an extruded foam. In an example, the extruded foam can include a polyvinyl chloride. The component can be mounted on a body, such as an automotive body, with the gasket positioned between the component and the body to provide the weatherproof seal therebetween.

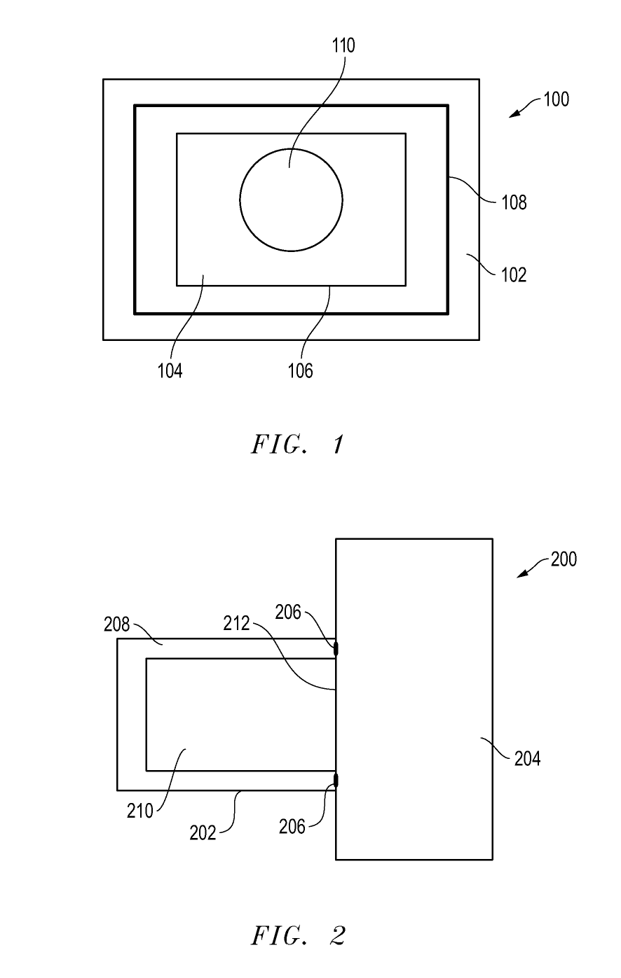

FIG. 1 illustrates a component 100, such as a lamp or camera housing. The component 100 can include an exterior wall 102 enclosing an interior space 104. Additionally, the component 100 can have an opening 106 into the interior space 104, and a rib 108 can extend from the exterior wall 102 and encircle the opening 106.

In an embodiment, at least a portion of the exterior wall 102 can be transparent or translucent to a portion of the electromagnetic spectrum, such as visible, infrared, and ultraviolet light. Additionally, the interior space 104 can house an active component 110, such as a camera or a lamp. The active component 110 can be active in the portion of the electromagnetic spectrum. For example, a lamp can emit visible light through the portion of the exterior wall 102 translucent to visible light, or a camera can capture infrared or visible light passing through a portion of the exterior wall 102 transparent to infrared light.

FIG. 2 illustrates a cross section of an assembly 200. The assembly can include a component 202, such as component 100, a body 204, and a gasket 206 disposed between the component 202 and the body 204. The component 202 can have an exterior wall 208 enclosing an interior space 210, and an opening 212 extending into the interior space 210. The opening 212 can be covered by the body 204 and the gasket 206 can provide a weatherproof seal between the component 202 and the body 204 to substantially prevent weather elements, such as rain, from penetrating into the interior space 210.

In an embodiment, the gasket 206 can be positioned over a rib of the component 202 and substantially encircle the opening 212. The gasket 206 can be an extruded foam having a groove extending along the length of the gasket 206. The rib of the component 202 can be inserted into the groove to hold the gasket in place. Additionally, the length of the gasket can extend around the opening 212, such that two ends of the gasket 206 meet. To ensure a weather proof seal, the two ends of the gasket 206 can be joined with a butyl tape.

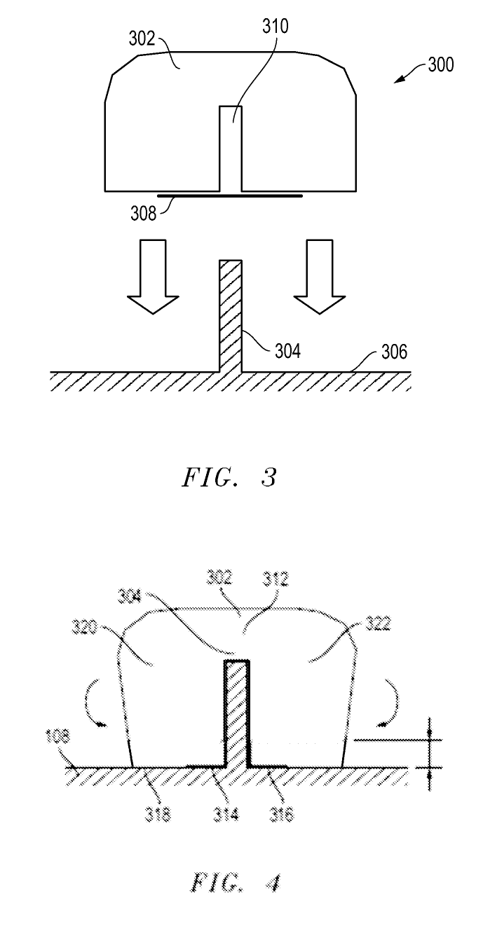

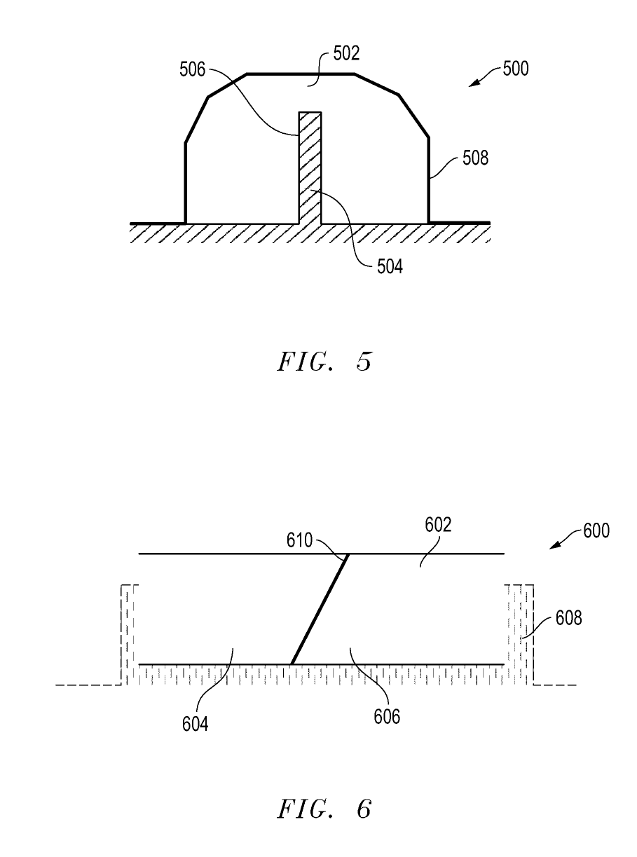

FIGS. 3 and 4 illustrate an exemplary gasket 302 at various stages of assembly. Referring to FIG. 3, prior to positioning on the rib 304 of the component 306, double sided tape 308 can be applied to gasket 302 spanning at least a portion of the groove 310.

The gasket can include a gasket material. The gasket material can be a foam, such as an extruded foam. Additionally, the foam can include a polymer, such as a polyvinyl chloride. The gasket material can have a density in a range of about 90 kg/m³ and about 235 kg/m³, such as in a range of about 100 kg/m³ and about 230 kg/m³, even in a range of about 110 kg/m³ and about 225 kg/m³. Additionally, the gasket material can have a force to achieve 30% compression in a range of about 17 kPa and about 180 kPa, such as in a range of about 18.5 kPa and about 100 kPa.

The double-sided tape 308 can include a substrate and an adhesive. The adhesive can be a pressure sensitive adhesive, such as a rubber-based adhesive, an acrylic-based adhesive, a silicone-based adhesive, and the like. In a particular embodiment, the adhesive is an acrylic-based adhesive. The substrate can include a paper, a polymer film, a foil, or the like. In a particular embodiment, the substrate can include a polymer film, such as a polyester film, a polyimide film, a vinyl film, or the like.

As the rib 304 is inserted into the groove 310 of the gasket 302, as shown in FIG. 4, a center portion 312 of the double sided tape 308 is forced into the receiving groove 310. Edge portions 314 and 316 of the double sided tape remain affixed to the contacting surface 318 of the gasket 302 and draw the side portions 320 and 322 of the gasket 302 inward. With the side portions 320 and 322 drawn inward towards the rib 304, the gasket 302 can form a tight seal between the gasket 302 and the component 306, substantially preventing weather elements, such as rain, from penetrating into the interior space of the component 306 at the interface between the component 306 and the gasket 302. In another embodiment (not illustrated in FIG. 4), rib 304 has a greater length and groove 310 cannot fully accommodate the entire rib 304. As a result, there is a gap between gasket 302 and the component 306. The gap results from the difference between the height of rib 304 and the depth of groove 310.

FIG. 5 illustrates a cross section 500 of the joined ends of the gasket 502. With the rib 504 inserted into the groove 506, the gasket can be guided along the rib 504 until the ends of the gasket 502 meet when the gasket 502 completely encircles the opening. A piece of butyl tape 508 can be applied overtop of the gasket 502 at the joint between the two ends to substantially prevent weather elements from penetrating the interface between the ends of the gasket 502.

FIG. 6 illustrates a side view 600 of joined ends of a gasket 602 illustrating an alternate method of joining the ends 604 and 606 of the gasket 602. With the rib 608 inserted into the groove, the gasket can be guided along the rib 608 until the ends 604 and 606 of the gasket 602 meet. A piece of butyl tape 610 can be applied at the interface between the two ends 604 and 606 to substantially prevent weather elements from penetrating the interface between the ends 604 and 606 of the gasket 602.

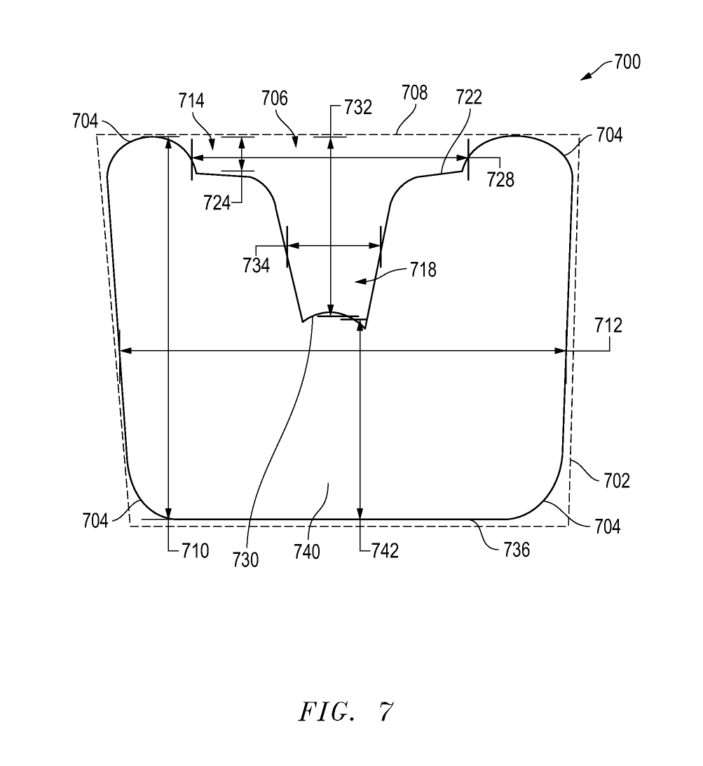

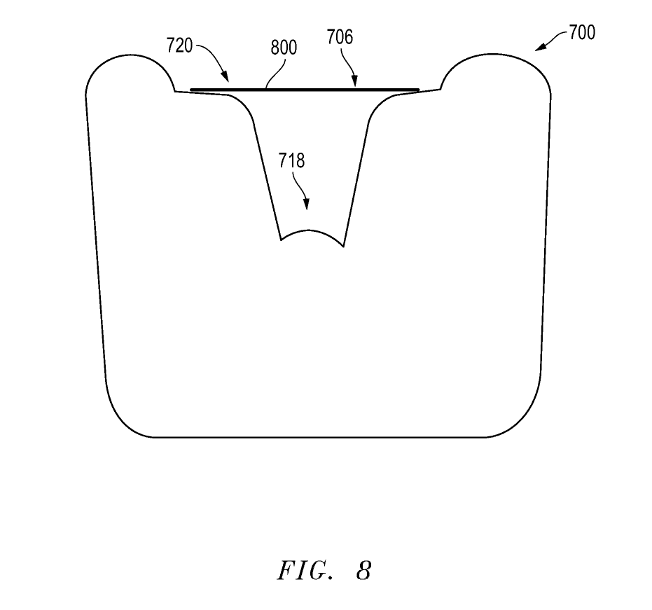

FIG. 7 illustrates a cross-section of an exemplary gasket 700. The gasket 700 can resemble, in cross section, a quadrilateral 702 with rounded vertices 704 and a groove 706 extending inwards from an edge 708 of the quadrilateral 702. In an embodiment, quadrilateral 702 can be a rectangle, a square, a parallelogram, a trapezoid, or the like. The gasket 700 can have a height 710 and a width 712, substantially corresponding to the height and width of the quadrilateral 702. In a particular embodiment, the height 710 can be in a range of about 5mm to about 20 mm, such as about 7 mm to about 15 mm, and the width 712 can be in a range of about 5 mm to about 20 mm, such as about 7 mm to about 15 mm.

The groove 706 can include a guide channel 714 and a receiving channel 718 substantially centered within the guide channel 714. The guide channel 714 can be used for positioning a piece of double-sided acrylic tape extending along the length of the groove 706. The receiving channel 716 can receive a rib of a component. In an embodiment, the guide channel 714 can have a depth 724 in a range of about 0.1 mm to about 1 mm and a width 728 in a range of about 4 mm to about 10 mm. The receiving channel 718 can have a depth 732 in a range of about 2 mm to about 10 mm, such as about 3 mm to about 7 mm, and a width 734 of about 1 mm to about 4 mm. In a particular embodiment, a ratio between the width 728 of the guide channel and the width of the receiving channel can be at least 2:1, such as at least 3:1, but generally not greater than about 10:1. Additionally, the ratio between the depth 732 of the receiving channel 718 and the width 734 of the receiving channel 718 can be at least 2:1 and generally not greater than 5:1, and the ratio of the depth 724 of the guide channel 714 to the width 728 of the guide channel 714 can be not greater than 1:20, such as not greater than 1:15, but generally at least 1:5.

Additionally, the gasket 700 can have a compressible portion 740 defined as the gasket material between the base 730 of the receiving groove 718 and the base 736 of the gasket 700. The compressible portion 740 can have a depth 742 in a range of about 2 mm to about 10 mm, such as about 3 mm to about 7 mm.

FIG. 8 illustrates a cross section of exemplary gasket 700 with the addition of a double-sided tape 800 within the guide channel 714. Double-sided tape 800 can be positioned to span the receiving channel 718.

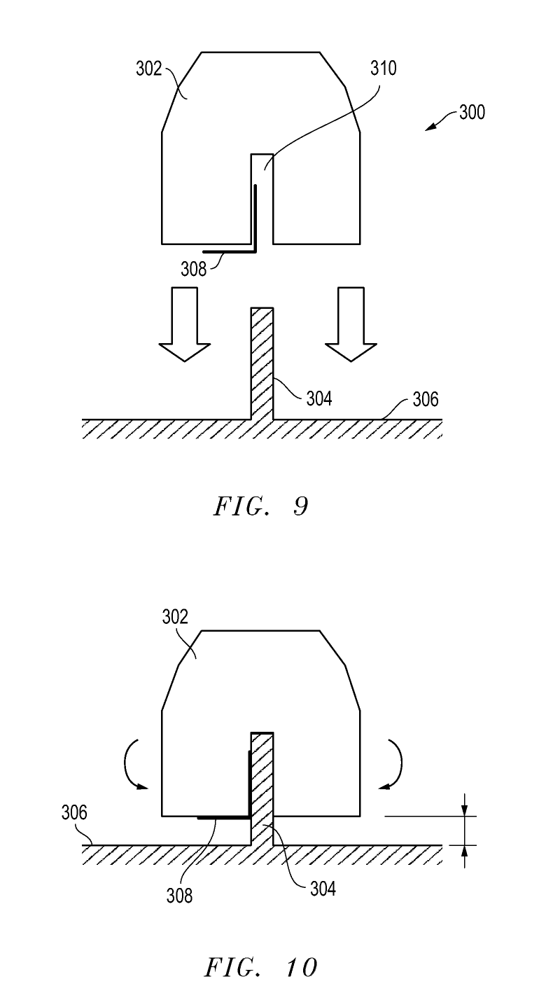

FIGS. 9 and 10 illustrate a variation of the embodiment disclosed in FIGS. 3 and 4 regarding an exemplary gasket 302 at various stages of assembly. Referring to FIG. 9, prior to positioning on the rib 304 of the component 306, double sided tape 308 can be applied to gasket 302 spanning a portion of the groove 310.

The gasket can include a gasket material. The gasket material can be a foam, such as an extruded foam. Additionally, the foam can include a polymer, such as a polyvinyl chloride. The gasket material can have a density in a range of about 90 kg/m³ and about 235 kg/m³, such as in a range of about 100 kg/m³ and about 230 kg/m³, even in a range of about 110 kg/m³ and about 225 kg/m³. Additionally, the gasket material can have a force to achieve 30% compression in a range of about 17 kPa and about 180 kPa, such as in a range of about 18.5 kPa and about 100 kPa.

The double-sided tape 308 can include a substrate and an adhesive. The adhesive can be a pressure sensitive adhesive, such as a rubber-based adhesive, an acrylic-based adhesive, a silicone-based adhesive, and the like. In a particular embodiment, the adhesive is an acrylic-based adhesive. The substrate can include a paper, a polymer film, a foil, or the like. In a particular embodiment, the substrate can include a polymer film, such as a polyester film, a polyimide film, a vinyl film, or the like.

Referring to FIG. 10, as the rib 304 is inserted into the groove 310 of the gasket 302, as shown in FIG. 10, a portion of the double sided tape 308 is pressed into a part of the receiving groove 310. The double sided tape remain affixed to the contacting surface of the gasket 302 and draw the side portions of the gasket 302 inward. With the side portions drawn inward towards the rib 304, the gasket 302 can form a tight seal (not shown in FIG. 10) between the gasket 302 and the component 306, substantially preventing weather elements, such as rain, from penetrating into the interior space of the component 306 at the interface between the component 306 and the gasket 302. Alternatively and as shown in FIG. 10, there can be a gap between the gasket 302 and component 306. The gap results from the difference between the height of rib 304 and the depth of groove 310.

Turning to the method of forming the gasket and sealing an assembly, a polymer foam, such as a polyvinyl chloride foam, can be extruded through a die having a shape corresponding to the cross section of the gasket. A double-sided tape can be placed within the groove, and the gasket can be applied to a component. The component can have a rib extending from the component and surrounding an opening. In a particular embodiment, the component can be an automotive part, such as a housing for a lamp. The gasket can be positioned over the rib, such that the double-sided tape is located between the gasket and the rib and the gasket surrounds the opening with two ends of the gasket meeting, such as at a butt joint. Additionally, a sealant, such as a butyl tape, can be applied to the butt joint.

In an embodiment, the gasket can be provided a long roll of material several times the length needed to surround the opening of the component. The gasket can be cut as needed to a length sufficient to surround the opening. In a further embodiment, the gasket can be provided with a pressure sensitive adhesive applied within the groove or a length of double-sided tape pre-positioned within the groove. The pressure-sensitive adhesive or double-sided tape may have a protective film that can be removed just prior to applying the gasket to the component. The protective film can substantially prevent dust, dirt, and the like from contacting the surface of the pressure sensitive adhesive or double sided tape.

The component with the attached gasket can be inserted into a body, such as an automotive body. When in place, the gasket can form a water tight seal between the component and the body. The seal can have a pressurized water rating of at least 0.13 kg/cm². The pressurized water rating can be measured by observing bubbles through sealed boundary by gasket. The gasket can be placed between lamp housing and plate. Air is injected inside of the assembly up to a test pressure, such as 0.13 kg/cm². The pressure is maintained within the assembly while the assembly is immersed in a water bath. The assembly is tested for air leaks by observing bubbles emanating from the seal. Absence of air leaking from the assembly, as evidenced by the lack of bubbles, indicates the seal has a pressurized water rating of at least the test pressure.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A sealing assembly comprising:
a component having a wall, an interior space defined by the wall, and an opening extending through the wall into the interior space, the wall having a rib extending therefrom and surrounding the opening;
a polyvinyl chloride foam gasket having first and second ends, a length, and a groove formed therein and defined by two sides and a base of the gasket, the groove extending along the length of the gasket, the gasket positioned along the rib such that the rib extends into the groove, the gasket extending around the opening such that the first and second ends of the gasket abut;
a double sided acrylic tape positioned between the rib and the groove to adhere the gasket to the rib and to pull the sides of the gasket towards the rib when the rib is inserted into the groove; and
a butyl tape positioned at the first and second ends of the gasket.

2. A sealing assembly of claim 1 wherein the component is an automotive component.

3. A sealing assembly of claim 1, wherein the automotive component is a lamp assembly.

4. A sealing assembly of claim 1, wherein the sealing assembly has a pressurized water rating of at least 0.13 kg/cm².

5. (canceled)

6. The sealing assembly of claim 1, wherein the material has a density in a range of about 90 kg/m³ and about 235 kg/m³.

7. (canceled)

8. (Canceled)

9. The sealing assembly of claim 1, wherein the material has a force to achieve 30% compression in a range of about 17 kPa and about 180 kPa.

10. (canceled)

11. (canceled)

12. (canceled)

13. A method of sealing a component, comprising:
providing the component, the component having a wall, an interior space defined by the wall, and an opening extending through the wall, the wall having a rib extending therefrom and surrounding the opening;
applying a gasket to the rib, the gasket comprising a polyvinyl chloride foam having first and second ends, a substantially rectangular cross section, and a groove formed therein and defined by two sides and a base of the gasket, the groove extending along the length of the gasket, the rib extending into the groove and bonded to the polyvinyl chloride foam with a double sided acrylic tape, the first and second ends abutting; and
applying a butyl tape to join the first and second ends.

14. The method of claim 13, further comprising positioning the acrylic tape within the groove prior to applying the gasket to the rib.

15. The method of claim 13, further comprising inserting the component into a body to form a water tight seal.

16. (canceled)

17. A gasket comprising:
a strip of material having a length and a groove formed therein and extending along the length, the material having a cross-section perpendicular to the length, and, in the cross-section, the groove including an guide channel for aligning a double sided acrylic tape and a receiving channel, the receiving channel substantially centered within the guide channel.

18. The gasket of claim 17, wherein the material includes a foam.

19. (canceled)

20. The gasket of claim 17, wherein the material includes a polyvinyl chloride foam.

21. The gasket of claim 17, wherein the material has a density in a range of about 90 kg/m³ and about 235 kg/m³.

22. The gasket of claim 17, wherein the material has a force to achieve 30% compression in a range of about 17 kPa and about 180 kPa.

23. The gasket of claim 17, wherein the material has a height in a range of about 5 mm to about 20 mm.

24. (canceled)

25. The gasket of claim 17, wherein the material has a width in a range of about 5 mm to about 20 mm.

26. (canceled)

27. The gasket of claim 17, wherein the groove has a receiving channel depth in a range of about 2 mm to about 10 mm.

28. (canceled)

29. The gasket of claim 17, wherein the groove has a receiving channel width in a range of about 1 mm to about 4 mm.

30. The gasket of claim 17, wherein the groove has a ratio of a receiving channel depth to a receiving channel width of at least 2:1.

31.-35. (canceled)

36. The gasket of claim 17, wherein the material includes first and second ends joined together with a sealant.

37.-40. (canceled)
